(19) United States
(12) Patent Application Publication
(10) Pub. No.: US 2017/0337832 A1
(43) Pub. Date: Nov. 23, 2017

(54) LANGUAGE COMPREHENSION SYSTEM

(71) Applicant: Colleen Janssen, Minnetonka, MN (US)

(72) Inventor: Colleen Janssen, Minnetonka, MN (US)

(21) Appl. No.: 15/583,691

(22) Filed: May 1, 2017

Related U.S. Application Data
(60) Provisional application No. 62/329,724, filed on Apr. 29, 2016.

(51) Int. Cl. G09B 1/08; G09B 19/00

(52) U.S. Cl. CPC G09B 1/08; G09B 19/00

(57) ABSTRACT

The invention provides language comprehension systems, including but not limited to, tactile teaching apparatuses and methods of using the same. In certain embodiments, the teaching apparatus may provide a sequence of outlined display windows in which selected pictorial representations may be placed, wherein each pictorial representation may represent single items or activities that a child engages with or in during a predetermined routine, thereby explaining to a child viewer what s/he will do during the predetermined routine. The apparatus may optionally include incentive indicators, such as stars or other items to provide encouragement or acknowledge success or completion of activities. The teaching apparatus may include a display board adapted to receive magnetized and/or erasable marked pictorial representations. The teaching apparatus may further be used to assist in communicating between patients and hospital, medical or dental personnel, or personnel in living facilities.

This application claims benefit of U.S. Provisional Application No. 62/329,724, filed on Apr. 29, 2016 and which application is incorporated herein by reference. A claim of priority is made.

### BACKGROUND OF THE INVENTION

The present invention relates to teaching systems and, more particularly, a language comprehension system embodying a teaching apparatus and a method of using the same.

The communication breakdown between a child and parent/guardian/teacher are, at least in part, a direct result of the child having difficulty understanding the temporal relationship between verbal directions and how that relationship translates through the course of a child's day.

Current language comprehension systems in the field are computer-implemented methods that do not embody a hands-on, ready-to-use, three-dimensional object that is tactilely accessible to the general public.

As can be seen, there is a need for a language comprehension system embodying a hands-on, ready-to-use, three-dimensional teaching apparatus and a method of using the same.

### BRIEF DESCRIPTION OF THE DRAWINGS

FIG. 1 is an elevation view of an exemplary embodiment of a teaching apparatus of the present invention;

FIG. 2 is a schematic view of an exemplary embodiment of the teaching apparatus of the present invention;

FIG. 3 shows various views of an exemplary embodiment of a plurality of pictorial representations of the present invention; and

FIG. 4 shows various views of an exemplary embodiment of a plurality of pictorial representations of the present invention.

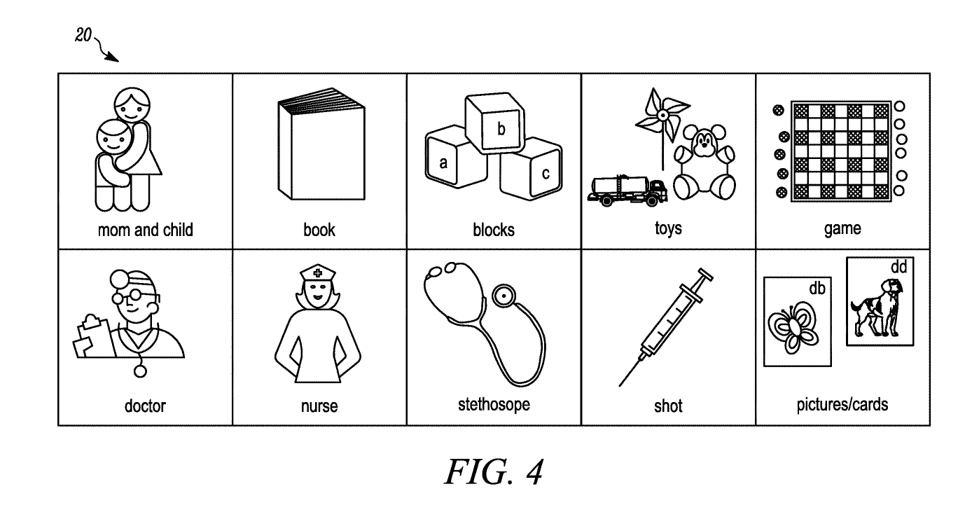

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the present invention.

Broadly, an embodiment of the present invention provides a language comprehension system embodying a tactile teaching apparatus and a method of using the same. The teaching apparatus may provide a sequence of outlined display windows in which selected pictorial representations may be placed, wherein each pictorial representation may represent single items or activities that a child engages with or in during a predetermined routine, thereby explaining to a child viewer what s/he will do during the predetermined routine. The teaching apparatus may include a display board adapted to received magnetized and/or erasable marked pictorial representations.

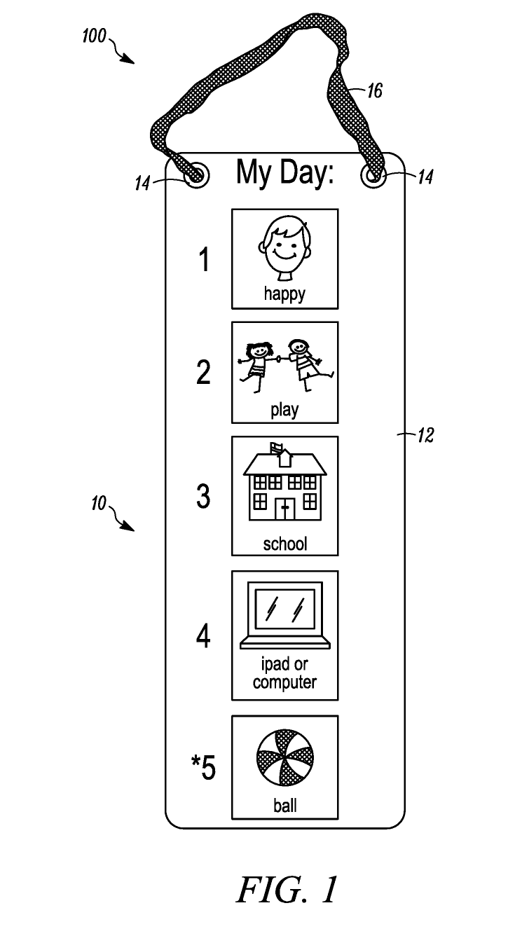

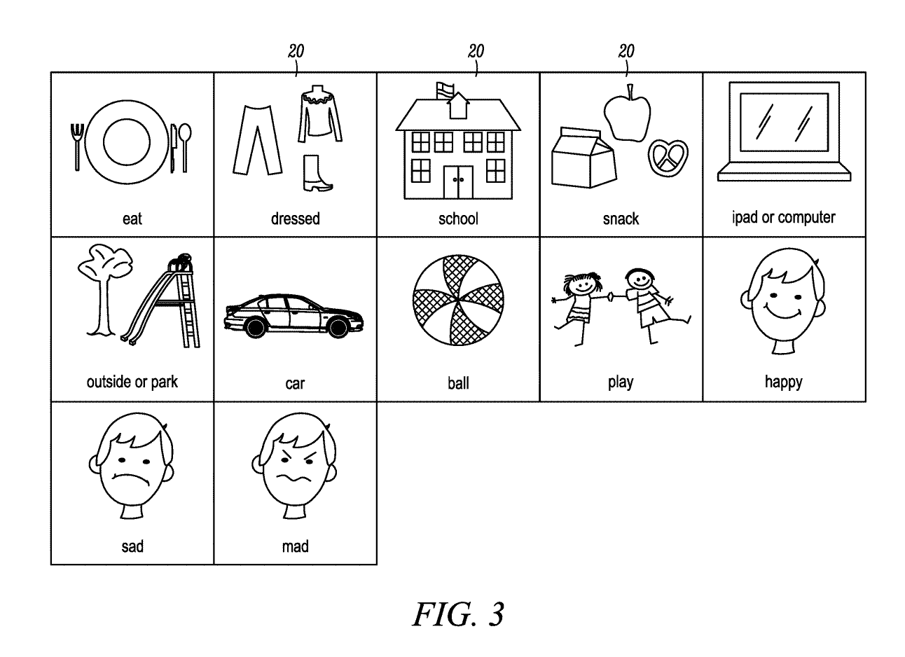

Referring now to FIGS. 1 through 3, the present invention may include a language comprehension system 100 embodying a tactile teach apparatus 10 and a method of using the same.

The teaching apparatus 10 may include a display board 12, where the display board 12 is made, at least in part, of a magnetically attractive material that selectively receives erasable markings. The magnetically attractive material may be any ferromagnetic material. The erasable markings may be made by a dry-erase marker, chalk or the like. In certain embodiments, the display board 12 may include a thick board or piled paper with magnets attached to the back of the display board 12.

The display board 12 may be elongated, extending between a first end and an opposing second end. Along the length of the display board 12, there may be a plurality of outlined display windows 18. Each display window 18 may be dimensioned and adapted to receive at least one of a plurality of pictorial representations 20. Each pictorial representation 20 may be magnetized and thus removably connected to an associated display window, or each pictorial representation 20 may be formed by use of the erasable markings. At least one grommet 14 may be provided near the first end. The display board 12 may include an adjustable strap 16 adapted to slide through the at least one grommet 14, as illustrated in FIG. 1.

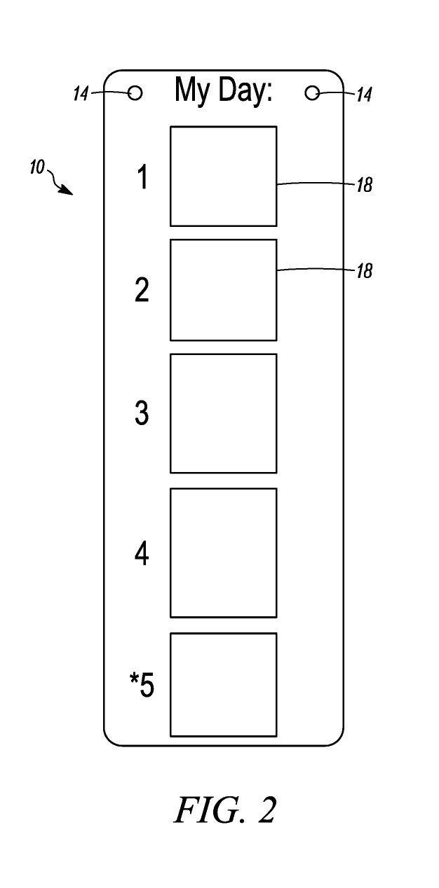

Each pictorial representation 20 may represent single items or activities that a child engages with or in during a predetermined routine. The sequential disposition of the display windows 18 from end to end represents the temporal order within each item/activity should be placed according to the predetermined routine. The display windows 18 may be sequentially numbered, as illustrated in FIGS. 1 and 2, to reinforce their temporal relationship, as well as to teach numbers.

A method of using the present invention may include the following. The teach apparatus 10 disclosed above may be provided. The teach apparatus 10 may be used to help a child to visualize the activities/events in a sequence throughout the predetermined routine. A user/parent/guardian/teacher may place at least one pictorial representation 20 within at least one of the display windows 18. By seeing and mentally sequencing the pictorial representations 20, the viewing child processes the associated language comprehension, divining sequencing and temporal relationships and connecting expressive language with feelings and thoughts, thereby explaining to the child viewer what s/he will do during the predetermined routine. The user may hang the display board 12 on a doorknob or refrigerator door or on a car seat via the adjustable strap 16 that weaves through the grommets 14 near the top of the display board 12.

It should be understood, of course, that the foregoing relates to exemplary embodiments of the invention and that modifications may be made without departing from the spirit and scope of the present invention.

What is claimed is:

1. A language comprehension system embodying a tactile teach apparatus and a method of using the same, as herein disclosed and described herein.
